(19) United States
(12) Patent Application Publication
(10) Pub. No.: US 2026/0235470 A1
(43) Pub. Date: Aug. 13, 2026

(54) METHOD AND SYSTEM FOR MODIFYING A PHOTONIC CHIP HAVING A SEMICONDUCTOR WAVEGUIDE

(71) Applicant: FEMTUM INC., Québec (CA)

(72) Inventors: Louis-Rafaël ROBICHAUD, Québec (CA); Simon DUVAL, Québec (CA)

(21) Appl. No.: 18/876,336

(22) PCT Filed: Jun. 26, 2023
(86) PCT No.: PCT/CA2023/050882

§ 371 Date: Dec. 18, 2024

Related U.S. Application Data
(60) Provisional application No. 63/355,678, filed on Jun. 27, 2022.

(51) Int. Cl. G01M 11/00

(52) U.S. Cl. CPC G01M 11/31

(57) ABSTRACT

There is described a method of modifying a photonic chip having a semiconductor waveguide. The method generally has: directing a focal point of a corrective laser beam within a portion of the photonic chip being one of proximate to and within the semiconductor waveguide, the corrective laser beam having a central wavelength greater than a bandgap wavelength of the semiconductor waveguide, said directing modifying an effective refractive index of the portion of the semiconductor waveguide; performing a testing routine on the semiconductor waveguide including determining a parameter indicative of a performance of the semiconductor waveguide; and upon determining that said parameter mismatches a reference parameter associated with a reference photonic chip, repeating said directing and said testing routine until said parameter matches the reference parameter within a given tolerance.

### FIELD

The improvements generally relate to photonic chips and more particularly to the manufacturing and testing of such photonic chips.

### BACKGROUND

In a manner analogous to electronic chips processing electronic signals, photonic chips process optical signals. Photonic chips are typically manufactured using foundry processes used for microelectronics manufacturing. Microelectronics foundry processes can reach tolerances of about 1.5 nm at the most which while satisfactory for state-of-the-art microelectronics may be insufficient for photonic chip manufacturing. As such, each photonic chip manufactured using known foundry processes is rigorously inspected and tested to make sure it is conform to design specifications. Once a photonic chip has been identified as defective, it can be discarded which can make for significant losses in terms of materials and time. Although existing techniques for manufacturing photonic chips are satisfactory to a certain degree, there remains room for improvement.

### SUMMARY

There is described methods and systems which are configured for modifying photonic chips and especially photonic chips that have been identified as defective for failing to meet design tolerance(s) and/or performances parameter(s) according to individual inspection and testing. The methods and systems involve a testing routine in which parameter(s) indicative of a performance of the photonic chip's semiconductor waveguide(s) is measured and in some cases monitored over time. Examples of such parameters can include, but are not limited to, wavelength, phase, amplitude, polarization, dispersion, gain and/or loss, to name a few examples. A corrective laser beam being selected to exhibit a central wavelength greater than a bandgap wavelength of the semiconductor waveguide(s) is then used to perform local modification(s) of an effective refractive index of the semiconductor waveguide(s). Such local modification(s) can be performed iteratively until the monitored parameters match corresponding reference parameters of a reference photonic chip. It is noted that as the semiconductor waveguides are optically transparent to the corrective laser beam, a focal point thereof can be directed through the photonic chip, e.g., through its cladding layer or substrate. When the focal point of the corrective laser beam delivers enough optical energy at a localized portion of the semiconductor waveguide(s), localized volumetric refractive index modifications can be created. In at least some instances, these localized volumetric matter modifications can result in the tuning of the performance of a defective photonic chip up to a level where the photonic chip can become defectless.

In accordance with a first aspect of the present disclosure, there is provided a method of modifying a photonic chip having a semiconductor waveguide, the semiconductor waveguide having a bandgap wavelength, the method comprising: directing a focal point of a corrective laser beam within a portion of the photonic chip being one of proximate to and within the semiconductor waveguide, the corrective laser beam having a central wavelength greater than the bandgap wavelength of the semiconductor waveguide, said directing modifying an effective refractive index of the portion of the semiconductor waveguide; performing a testing routine on the semiconductor waveguide including determining a parameter indicative of a performance of the semiconductor waveguide; and upon determining that said parameter mismatches a reference parameter associated with a reference photonic chip, repeating said directing and said testing routine until said parameter matches the reference parameter within a given tolerance.

Further in accordance with the first aspect of the present disclosure, the directing can for example include moving at least one of the focal point of the corrective laser beam and the photonic chip along a path.

Still further in accordance with the first aspect of the present disclosure, the moving can for example include delivering a laser pulse at each of a plurality of spaced apart points distributed along the path.

Still further in accordance with the first aspect of the present disclosure, the testing routine can for example include guiding a test optical signal into and along the semiconductor waveguide, detecting an output signal resulting from the guiding and determining the parameter based on the output signal.

Still further in accordance with the first aspect of the present disclosure, the guiding can for example include injecting the test optical signal at a first end of the semiconductor waveguide.

Still further in accordance with the first aspect of the present disclosure, the detecting can for example include measuring the output signal using a photodiode optically coupled to a second end of the semiconductor waveguide.

Still further in accordance with the first aspect of the present disclosure, the detecting can for example include measuring the output signal scattering away from the semiconductor waveguide during the guiding using a camera.

Still further in accordance with the first aspect of the present disclosure, the parameter can for example be at least one of an output wavelength, an output phase, an output amplitude, an output polarization, an output dispersion and an output loss.

Still further in accordance with the first aspect of the present disclosure, the central wavelength of the corrective laser beam can for example range between about 1 μm and about 20 μm, preferably between about 1.2 μm and about 10 μm and most preferably about between about 1.5 μm and about 4 μm.

Still further in accordance with the first aspect of the present disclosure, the corrective laser beam can for example have laser pulses having a time duration ranging between about 10 fs and about 1000 ns, preferably between about 100 fs and about 500 ns and most preferably between about 250 fs and about 250 ns.

Still further in accordance with the first aspect of the present disclosure, the semiconductor waveguide can for example be positioned relative to a substrate, the photonic chip can for example further have a cladding layer covering a top surface of the substrate and the semiconductor waveguide, the directing can for example include directing the focal point of the corrective laser beam through at least one of the cladding layer and the substrate.

Still further in accordance with the first aspect of the present disclosure, the photonic chip can for example have a plurality of semiconductor waveguides each having the bandgap wavelength, the method can for example comprise performing said directing and said testing routine with respect to each one of the plurality of semiconductor waveguides until a plurality of parameters pertaining to the plurality of semiconductor waveguides match a respective reference parameter within a given tolerance.

In accordance with a second aspect of the present disclosure, there is provided a system for modifying a photonic chip having a semiconductor waveguide, the semiconductor waveguide having a bandgap wavelength, the system comprising: a corrective laser apparatus configured for directing a focal point of a corrective laser beam within a portion of the photonic chip being one of proximate to and within the semiconductor waveguide, the corrective laser beam having a central wavelength greater than the bandgap wavelength of the semiconductor waveguide, said directing modifying an effective refractive index of the semiconductor waveguide; a photonic chip testing apparatus performing a testing routine on the semiconductor waveguide including determining a parameter indicative of a performance of the semiconductor waveguide; and a controller communicatively coupled to the corrective laser apparatus and to the photonic chip testing apparatus, the controller having a processor and a memory having stored thereon instructions that when executed by the processor perform the steps of: comparing said parameter to a reference parameter associated with a reference photonic chip; and upon determining that said parameter mismatches the reference parameter, repeating said directing and said testing routine until said parameter matches the reference parameter within a given tolerance.

Further in accordance with the second aspect of the present disclosure, the corrective laser apparatus can for example include a laser source generating the corrective laser beam, the central wavelength ranging between about 1.0 μm and about 20 μm, preferably between about 2.5 μm and about 10 μm and most preferably about between about 2.8 μm and about 3.4 μm.

Still further in accordance with the second aspect of the present disclosure, the corrective laser apparatus can for example include a laser source generating laser pulses having a time duration ranging between about 10 fs and about 1000 ns, preferably between about 100 fs and about 500 ns and most preferably between about 250 fs and about 250 ns.

Still further in accordance with the second aspect of the present disclosure, the corrective laser apparatus can for example have a fiber laser source.

Still further in accordance with the second aspect of the present disclosure, the system can for example further comprise a multi-axis movement stage having a support area on which the photonic chip is received, the multi-axis movement stage can for example move the photonic chip during the directing.

Still further in accordance with the second aspect of the present disclosure, the photonic chip testing apparatus can for example include a test optical source guiding a test optical signal into and along the semiconductor waveguide, and a detector detecting an output signal resulting from the guiding, the controller can for example determine the parameter based on the output signal.

Still further in accordance with the second aspect of the present disclosure, the detector can for example be a photodiode optically coupled to a first end of the semiconductor waveguide for detecting the output signal.

Still further in accordance with the second aspect of the present disclosure, the detector can for example be an infrared camera measuring the output signal scattering away from the semiconductor waveguide during the guiding.

In accordance with a third aspect of the present disclosure, there is provided a method of testing a photonic chip, the photonic chip having a semiconductor waveguide and a plurality of semiconductor components optically coupled to the semiconductor waveguide, the semiconductor components having a bandgap wavelength, the method comprising: while performing a testing routine on the semiconductor waveguide, the testing routine including guiding a test optical signal into and along the semiconductor waveguide, detecting an output signal resulting from said guiding and monitoring an output signal based on said output signal, directing a focal point of a probing laser beam within a portion of the photonic chip being one of proximate to and within one of the plurality of semiconductor components, the corrective laser beam having a central wavelength greater than the bandgap wavelength of the semiconductor components, said directing modifying an effective refractive index of the portion of the one of the semiconductor components; identifying an optical feature in the output spectrum being modified in response to said directing; and associating the optical feature to the one of the semiconductor components.

Further in accordance with the third aspect of the present disclosure, said modifying can for example include modifying the effective refractive index of the portion of the semiconductor waveguide by an amount ranging between about 0.1 and about 0.00000001, preferably between about 0.05 and about 0.0005 and most preferably between about 0.01 and about 0.001.

In accordance with a fourth aspect of the present disclosure, there is provided a system for testing a photonic chip, the photonic chip having a semiconductor waveguide and a plurality of semiconductor components optically coupled to the semiconductor waveguide, the semiconductor components having a bandgap wavelength, the system comprising: a photonic chip testing apparatus performing a testing routine including guiding a test optical signal into and along the semiconductor waveguide, detecting an output signal resulting from said guiding and monitoring an output spectrum based on said output signal; a corrective laser apparatus configured for directing a focal point of a corrective laser beam within a portion of the photonic chip being one of proximate to and within one of the semiconductor components, the corrective laser beam having a central wavelength greater than the bandgap wavelength of the semiconductor waveguide, said directing modifying an effective refractive index of the portion of the one of the semiconductor components; and a controller communicatively coupled to the photonic chip testing apparatus and the corrective laser apparatus, the controller having a processor and a memory having stored thereon instructions that when executed by the processor perform the steps of: identifying an optical feature in the output spectrum being modified in response to said directing; and associating the optical feature to the one of the semiconductor components.

All technical implementation details and advantages described with respect to a particular aspect of the present disclosure are self-evidently mutatis mutandis applicable for all other aspects of the present disclosure.

It is noted that the expression “proximate to the semiconductor waveguide” is meant to encompass any location of the photonic chip outside the semiconductor waveguide which, when modified using a focal point of a corrective laser beam, can influence the effective refractive index of the semiconductor waveguide. For instance, in some embodiments, such locations can include the material matrix surrounding the semiconductor waveguide, the substrate on which the semiconductor guide lies or above which it is suspended.

Many further features and combinations thereof concerning the present improvements will appear to those skilled in the art following a reading of the instant disclosure.

### DESCRIPTION OF THE FIGURES

In the figures,

FIG. 1 is a schematic view of an example of a system for modifying a photonic chip having a semiconductor waveguide, in accordance with one or more embodiments;

FIG. 2 is a graph showing an optical transmission window of the semiconductor waveguide of FIG. 1 and a central wavelength of a corrective laser beam, in accordance with one or more embodiments;

FIG. 3A is an oblique view of the photonic chip of FIG. 1 onto which a testing routine is being performed and showing a measured parameter mismatch, in accordance with one or more embodiments;

FIG. 3B is an oblique view of the photonic chip of FIG. 1 receiving a corrective laser beam within the semiconductor waveguide, in accordance with one or more embodiments;

FIG. 3C is an oblique view of the photonic chip of FIG. 1 onto which a subsequent testing routine is being performed and showing a measured parameter match, in accordance with one or more embodiments;

FIG. 4 is a flow chart of an example of a method for modifying a photonic chip having a semiconductor waveguide, in accordance with one or more embodiments;

FIGS. 5A to 5D are top plan views of exemplary semiconductor waveguides forming different photonic components, showing a corrective laser beam being directed at a plurality of locations relative to the semiconductor waveguide, in accordance with one or more embodiments;

FIGS. 6A to 6D are top plan views of exemplary semiconductor waveguides of a given photonic component, showing a corrective laser beam being moved along different patterns relative to the semiconductor waveguide, in accordance with one or more embodiments;

FIG. 6E is a top plan view of an example of a semiconductor waveguide, showing corrective laser beams of different intensities being directed at different locations relative to the semiconductor waveguide, in accordance with one or more embodiments;

FIG. 6F is a top plan view of an example of a semiconductor waveguide, showing corrective laser beams of different central wavelengths being directed at different locations relative to the semiconductor waveguide, in accordance with one or more embodiments;

FIG. 6G is a top plan view of an example of a semiconductor waveguide, showing corrective laser beams of different spatial modes being directed at the semiconductor waveguide, in accordance with one or more embodiments;

FIG. 7A is a side elevation view of an example photonic chip, showing a corrective laser beam being directed to the semiconductor waveguide through an upper cladding layer, in accordance with one or more embodiments;

FIG. 7B is a side elevation view of an example photonic chip, showing a corrective laser beam being directed to the semiconductor waveguide through a substrate, in accordance with one or more embodiments;

FIG. 8 is a side elevation view of an example of a photonic chip being modified by a corrective laser beam, showing dimensions of the corrective laser beam and dimensions of the semiconductor waveguide, in accordance with one or more embodiments;

FIG. 9 is a flow chart of an example of a method for testing a photonic chip having semiconductor components, in accordance with one or more embodiments;

FIG. 10 is a top plan view of an example of a photonic chip having semiconductor components, in accordance with one or more embodiments;

FIG. 11A is a top plan view of an example of a Mach-Zehnder interferometer arm having a semiconductor waveguide and refractive index modifications made proximate thereto, in accordance with one or more embodiments;

FIG. 11B is a graph showing the fine tuning of the refractive index of the semiconductor waveguide of FIG. 11A for different amounts of refractive index modifications, in accordance with one or more embodiments;

FIG. 12A is a top plan view of an example of a Mach-Zehnder interferometer arm having a semiconductor waveguide and refractive index modifications made within the semiconductor waveguide, in accordance with one or more embodiments;

FIG. 12B is a graph showing the coarse tuning of the refractive index of the semiconductor waveguide of FIG. 12A for different amounts of refractive index modifications onto the semiconductor waveguide, in accordance with one or more embodiments;

FIG. 13A is a graph showing post-manufacture spectral responses for different semiconductor components each including a Mach-Zehnder interferometer, in accordance with one or more embodiments;

FIG. 13B is a graph showing the spectral responses of the semiconductor components of FIG. 13A after coarse and/or fine tuning using refractive index modifications made within and/or proximate to the corresponding semiconductor waveguide; and

FIG. 14 is a schematic view of an example of a computing device of a controller, in accordance with one or more embodiments.

### DETAILED DESCRIPTION

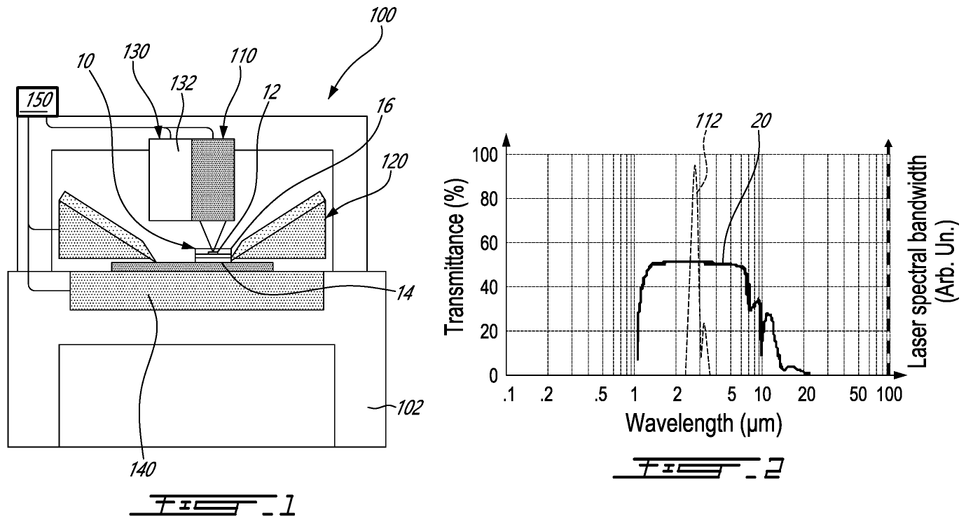

FIG. 1 shows an example of a system 100 for modifying a photonic chip 10 having a semiconductor waveguide 12. The system 100 can be used at any testing stages of the manufacture of the photonic chip 10. For instance, the system 100 can be used at a design stage where the photonic chip 10 is prototyped and corrected iteratively as desired, at a foundry stage where the photonic chip 10 is mass produced and/or at a packaging stage where the photonic chip 10 is integrated into a package, for instance.

It is noted that the semiconductor waveguide 12 can involve any type of semiconductor material including, but not limited to, silicon, silicon nitride (SIN), silicon-on-insulator (SOI), silicon nitride (Si3N4), germanium (Ge), indium phosphide (InP), silicon carbide (SIC), gallium nitride (GaN), indium gallium arsenide (InGaAs), gallium arsenide (GaAs), lithium niobate (LiNbO3), indium antimonide (InSb), mercury cadmium telluride (MCT), insidum arsenide (InAs), lead selenide (PbSe), lead sulfide (PbS), chalcogenide-based materials such as sulphide-based materials, selenide-based materials, telluride-based materials, any doped semiconductor including n-type doping, p-type doping, germanium doping, silicon doping, boron doping, arsenic doping, carbon doping, helium doping, antimony doping, and/or active laser material doping such as rare earth ion doping like erbium, ytterbium, quantum dot, gas.

The semiconductor waveguide 12 can be any type of semiconductor waveguide used in photonic chips. For instance, the semiconductor waveguide 12 can have be a strip waveguide, a rib waveguide, a slot waveguide, a photonic crystal waveguide, a subwavelength waveguide grating (SWG) waveguide, a SWG slot waveguide, a SPP slot waveguide and the like. Typically, the photonic chip 10 includes a substrate 14 to which the semiconductor waveguide 12 is positioned relative thereto. For instance, the semiconductor waveguide 12 can be directly received on the substrate 14 or indirectly received on the substrate 14 via a buried oxide layer, for instance. The substrate 14 can be a silicon substrate, a polymer substrate, a glass substrate or any other suitable type of substrate. In some embodiments, the semiconductor waveguide 12 is disposed atop the substrate 14. In these embodiments, the semiconductor waveguide 12 can run along a path which is substantially parallel to a plane of the substrate 14. The path can be linear, arcuate, circular, depending on the embodiment. In some other embodiments, the semiconductor waveguide 12 can be suspended over the substrate 14 or buried therein. The photonic chip 10 can include one or more cladding or metallic layers 16 partially or wholly covering the semiconductor waveguide 12 and/or a top surface of the substrate 14. The cladding or metallic layers 16 can be made of oxide in some embodiments. Moreover, there can be a buried oxide layer between the substrate 14 and the semiconductor waveguide 12 in some embodiments. In some embodiments, the cladding or metallic layers 16 can be made of any material of lower refractive index than the waveguide material that can allow the confinement and the propagation of an optical signal.

As shown, the system 100 has a corrective laser apparatus 110 and a photonic chip testing apparatus 120. In some embodiments, the system 100 can also incorporate a computer vision apparatus 130 incorporating a camera 132 imaging the photonic chip 10 in real time. A multi-axis movement stage 140 can optionally be used for moving the photonic chip 10 within a working zone as desired. The multi-axis movement stage 140 can be a translation stage and/or a rotation stage. In some embodiments, the corrective laser apparatus 110 can be made integral to existing photonic testing apparatuses.

The system 100 can have a controller 150 which is communicatively coupled to the corrective laser apparatus 110, the photonic chip testing apparatus 120, the computer vision apparatus 130 and/or the multi-axis moving stage 140, for instance. The controller 150 has a processor and a memory having stored thereon instructions that when executed by the processor perform preprogrammed instructions and/or method steps. To do so, the controller 150 generally incorporates hardware components provided in the form of a computing device and software components provided in the form of programs, algorithms and the like for performing the method steps. An example of the computing device is described below.

As depicted, the corrective laser apparatus 110, the photonic chip testing apparatus 120, the computer vision apparatus 130 and the multi-axis moving stage 140 can be fixedly or removably mounted to a frame 102. In this specific embodiment, the frame 102 is provided in the form of an optical bench or table. However, it is understood that in some other embodiments the corrective laser apparatus 110, the photonic chip testing apparatus 120, the computer vision apparatus 130 and the multi-axis moving stage 140 can be mounted independently from one another at different locations of a photonic chip production line, for instance. In some embodiments, electronic probes and/or fiber probes of the photonic chip testing apparatus 120 can be in the path of a corrective laser beam of the corrective laser apparatus 110. In these embodiments, the corrective laser apparatus 110, a laser source thereof or an output thereof can be moved as desired above or below the photonic chip 10. Such movement can be generated using a two-axes or three-axes galvanometer scanner, a coarse gantry mechanism for movement within a centimeter squared, a fine gantry mechanism for movement within a relatively small area (e.g., 100 μm×100 μm, 10×10 μm), a piezo micropositioner (e.g., an hexapod, a spatial light modulator (SLM)), an optical fiber cable with a microlens tip, a six degrees of freedom robotic arm, any other motion apparatus with or without moving part(s) that can translate and/or deflect the corrective laser beam, and/or any combination thereof

It is noted that all semiconductor materials have their own bandgap energies and corresponding bandgap wavelengths tied together via Planck relation. The bandgap energy and the bandgap wavelength define at which wavelengths or photon energies the semiconductor material exhibits at least some transparency. It is intended that the corrective laser beam is selected to that it has a central wavelength which is greater than the bandgap wavelength of the corresponding semiconductor waveguide. Equivalently, the corrective laser beam can have a photon energy which is below the bandgap energy of the semiconductor waveguide. For instance, lead selenide (PbSe) has a direct band gap of 0.27 eV or 4.57 μm; lead telluride (PbTe) has a direct band gap of 0.32 eV or 3.86 μm; indium arsenide (InAs) has a direct band gap of 0.36 eV or 3.43 μm; lead sulfide (PbS) has a direct band gap of 0.37 eV or 3.34 μm; germanium (Ge) has an indirect band gap of 0.67 eV or 1.84 μm; gallium antimonide (GaSb) has a direct band gap of 0.726 eV or 1.70 μm; silicon (Si) has an indirect band gap of 1.12 eV or 1.1 μm; indium phosphide (InP) has a direct band gap of 1.35 eV or 915 nm; gallium arsenide (GaAs) has a direct band gap of 1.441 eV or 857 nm; cadmium tellurite (CdTe) has a direct band gap of 1.5 eV or 823 nm; cadmium selenide (CdSe) has a direct band gap of 1.74 eV or 710 nm; aluminum arsenide (AlAs) has an indirect band gap of 2.12 eV or 583 nm; gallium phosphide (GaP) has an indirect band gap of 2.24 eV or 551 nm; cadmium sulfide (CdS) has a direct band gap of 2.42 eV or 510 nm; gallium nitride (GaN) has a direct band gap of 3.4 eV or 363 nm; cubic zinc sulfide (ZnS) has a direct band gap of 3.54 eV or 349 nm; hexagonal zinc sulfide (ZnS) has a direct band gap of 3.91 eV or 316 nm; and aluminum nitride (AlN) has a direct band gap of 6.015 eV or 205 nm, to name a few examples.

Referring now to FIG. 2, it is noted that the semiconductor waveguide of the photonic chip has a bandgap energy and corresponding bandgap wavelength defining an optical transmission window 20. The optical transmission window 20 can range between about 1 μm and about 25 μm, preferably between about 2.0 μm and about 20 μm and most preferably between about 2.5 μm and about 10 μm. For instance, in embodiments where the semiconductor waveguide includes silicon having a bandgap wavelength of about 1.1 μm, the optical transmission window can range between about 1.1 μm and about 15 μm. In such embodiments, the central wavelength of the corrective laser beam can be selected to be greater than 1.1 μm. For instance, mid infrared laser beams were found to be satisfactory. The optical transmission window typically exhibits transmittances ranging between about 1%/cm and about 10%/cm, for instance.

In view of the above, it is intended that the corrective laser beam has a central wavelength 112 extending at least partially or wholly within the optical transmission window 20 of the semiconductor waveguide. For instance, the central wavelength 112 of the corrective laser beam can range between about 1.0 μm and about 20 μm, preferably between about 2.5 um and about 10 μm and most preferably about between about 2.8 μm and about 3.4 μm. As such, optical energy can be delivered within the photonic chip, e.g., including within the semiconductor waveguide and/or proximate to the semiconductor waveguide. In embodiments where the semiconductor includes silicon, it was found convenient to use a mid-infrared laser beam having a narrow spectral bandwidth (or central wavelength, equivalently) centered at about 3.2 μm, for instance. It is noted that the mid-infrared laser beam can be generated using a fiber laser source having a fiber segment made of a low phonon energy glass and having at least one laser-active doped region extending along the fiber segment. An example of such a fiber laser source is described in U.S. Pat. No. 10,084,287B2, the contents of which are hereby incorporated by reference.

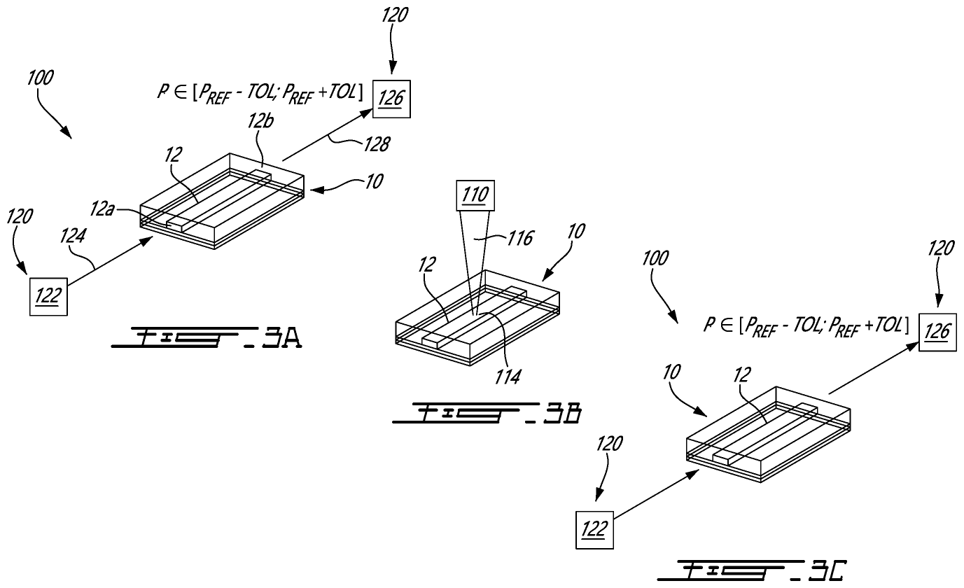

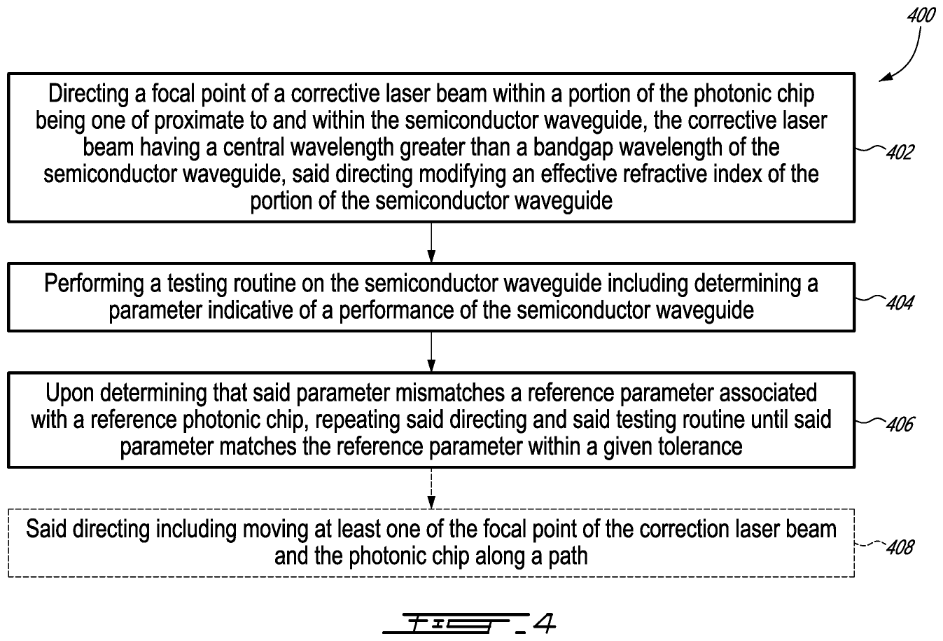

FIG. 3A shows the photonic chip 10 of FIG. 1 onto which a testing routine is being performed by the photonic chip testing apparatus 120. As shown, the photonic chip testing apparatus 120 determines a parameter P indicative of a performance of the semiconductor waveguide 12. When the measured parameter P and a reference parameter P_{REF} of a reference photonic chip mismatch to one another within a given tolerance TOL, i.e., when P∉[P_{REF}−TOL; P_{REF}+TOL], the photonic chip 10 may be identified as defective. Instead of discarding the defective photonic chip 10, the photonic chip 10 is modified using the system 100. The reference photonic chip may correspond to a photonic chip that is deemed to be defectless or conform to design tolerance(s), for instance. The reference parameter(s) P_{REF} can be stored on a memory system accessible to the controller 150. In some embodiments, each photonic chip being tested has an identifier identifying the type of photonic chip and one or more reference parameters P_{REF} associated to the type of photonic chip. When such a photonic chip is being tested, the controller can fetch the photonic type and/or the associated reference parameters P_{REF}.

In some embodiments, the photonic chip testing apparatus 120 has a test optical source 122 guiding a test optical signal 124 into and along a first end 12a of the semiconductor waveguide 12 and a detector 126 detecting an output signal 128 resulting from the guiding of the test optical signal 124. The test optical signal 124 can be injected using grating coupler(s), side coupler(s), free-space injection setup(s) and the like. The output optical signal 128 can be detected using an integrated photodiode, a fiber probe, a free space detector, a spectrophotometer, a standard, infrared or hyperspectral camera imaging scattering outgoing from the photonic chip 10, to name a few examples. In these embodiments, the controller can determine the parameter P based on the output signal 128. As shown in the specific embodiment of FIG. 3A, the detector can be a photodiode optically coupled to a second end 12b of the semiconductor waveguide 12 for detecting the output signal 128. In some embodiments, the detector is an infrared camera measuring the output signal scattering away from the semiconductor waveguide during the guiding of the test optical signal 124. The camera(s) can be part of the computer vision apparatus 130. It is intended that the testing routine needs not to be based solely on optical technologies. For instance, in some other embodiments, the testing routine involves optical modulation based on radio-frequency signals and/or electronic measurements.

As shown in FIG. 3B, the corrective laser apparatus 110 is used to direct a focal point 114 of a corrective laser beam 116 within a portion of the photonic chip 10 which is either one or both within or proximate to the semiconductor waveguide 12. Due to the optical transparency of the semiconductor waveguide 12 to the corrective laser beam 116, an effective refractive index of the portion of the semiconductor waveguide 12 can be modified by a certain extent, including positive or negative refractive index changes. The effective refractive index modification can cause the performance of the semiconductor waveguide 12 and overall photonic chip 10 to be modified accordingly.

As depicted in FIG. 3C, the modified photonic chip 10 can be tested again using the testing routine to determine whether the measured parameter P now matches the reference parameter PREF within the given tolerance TOL, i.e., if P∈[PP_{REF}−TOL; P_{REF}+TOL]. These steps can be repeated iteratively until a match is found, i.e., until the photonic chip 10 performs to a level where it can be deemed to be defectless. Once the modified photonic chip 10 has a pass on the testing routine, it can be put back into and along the photonic chip production line, thereby reducing the amount of photonic chips that are discarded after a failed testing routine. Considering that in some embodiments 50% to 80% of all photonic chips being produced using existing microelectronics foundry techniques may be defective, it is hypothesised that the system 100 can reduce such a photonic chip discard rate by at least 25%, preferably below at least 50% and most preferably at least 75% using the methods and systems described herein compared to conventional manufacturing processes. It is also noted that the methods and systems described herein can correct defective photonic chips at relatively high speed.

FIG. 4 shows an example of a method 400 of modifying a photonic chip having a semiconductor waveguide. Although the method 400 is described with reference to the system 100 and the photonic chip 10 of FIG. 1, it is understood that the method 400 can be applied to any photonic chip using any photonic chip modification system.

At step 402, the focal point 114 of the corrective laser beam 116 is directed within a portion of the photonic chip 10 which is one of proximate to and within the semiconductor waveguide 12. As discussed above, the corrective laser beam 116 has a central wavelength 112 greater than a bandgap wavelength of the semiconductor waveguide 12. As such, the step 402 modifies an effective refractive index of the portion of the semiconductor waveguide 12. The effective refractive index of the portion of the semiconductor waveguide 12 can be modified by an amount ranging between about 0.1 and about 0.00000001, preferably between about 0.05 and about 0.0005 and most preferably between about 0.01 and about 0.001. It is noted that the effective refractive index can be modified to increase or decrease the current effective refractive index of the semiconductor waveguide 12 depending on the embodiment.

At step 404, a testing routine is performed on the semiconductor waveguide 12. The testing routine generally includes a step of determining a parameter P indicative of a performance of the semiconductor waveguide 12. Depending on the embodiment, the parameter can be an output wavelength, an output phase, an output amplitude, an output polarization, an output dispersion, an output loss, and/or a combination thereof. The parameter P can be determined on the basis of an output signal 128 being detected by a detector 126 of the photonic chip testing apparatus 120.

At step 406, upon determining that the parameter P mismatches a reference parameter PREF associated with a reference photonic chip, the step 402 of directing and the step 404 of performing the testing routine are repeated iteratively until the parameter P matches the reference parameter P_{REF} within a given tolerance TOL. When the testing routine results in a pass, a pass signal may be generated and the now defectless photonic chip can be labeled accordingly in the photonic chip production line's databases, for instance.

It is noted that in some embodiments the photonic chip 10 can have a number of semiconductor waveguides 12 each having the bandgap wavelength. In these embodiments, the method 400 can include a step of performing the step 402 and the step of 404 with respect to each one of the semiconductor waveguides 12 until the parameters pertaining to the semiconductor waveguides 12 match a respective reference parameter within a given tolerance. In some embodiments, the reference parameters can be the same for each of the semiconductor waveguides 12. In some other embodiments, each semiconductor waveguide 12 has a dedicated reference parameter.

At step 408, the step 402 of directing can include a step of moving at least one of the focal point 114 of the correction laser beam 116 and the photonic chip 10 along a path. For instance, the step 408 includes moving the focal point 114 of the corrective laser beam 116 relative to the semiconductor waveguide 12 of the photonic chip 10. Additionally or alternatively, the step 402 includes moving the photonic chip 10 relative to the focal point 114 of the corrective laser beam 116. In these embodiments, the relative movement between the focal point 114 of the corrective laser beam 116 and the semiconductor waveguide 12 can define a path. The path can be parallel to a plane of the photonic chip 10 in some embodiments. For instance, the path can be linear, arcuate, circular and arbitrary depending on the embodiment. The path needs not to be confined to a plane as it can have a three-dimensional topography as well. It is noted that step 408 is optional as it can be omitted in some embodiments.

In some embodiments, the corrective laser beam 116 is pulsed and the step of moving the focal point 114 of the corrective laser beam 116 along a path includes the delivery of one or more laser pulses at each of a number of spaced apart points distributed evenly or unevenly along the path. The laser pulses can have a time duration ranging between about 10 fs and about 1000 ns, preferably between about 100 fs and about 500 ns and most preferably between about 250 fs and about 250 ns. The laser pulses can carry an optical fluence ranging between about 0.01 J/cm² and about 100 J/cm². The laser pulses can carry an optical energy ranging between about 1 nJ and about 1 mJ, preferably between about 10 nJ and about 0.1 mJ and most preferably between about 100 nJ and about 10 μJ. It is intended that the focal point 114 of the corrective laser beam 116 can be sufficiently intense to cause nonlinear absorption into the photonic chip 10. Examples of such nonlinear absorption mechanisms can include, but are not limited to, multi-photon absorption, tunnel ionisation, free-carrier absorption, impact ionisation, and the like. Such nonlinear absorption mechanisms are generally achieved using fast (sub μs) melting and resolidification light-matter processes. More specifically, such non-linear absorption mechanisms can excite the electrons from the valence band to the conduction band, thus generating free-carriers. The material modification, hereby the refractive index change, can depend on the density of carriers, their excited energy level (electron temperature) and/or the temporal dynamics of the energy transfers between the photon, electron and phonons. Generally, to maximize the possible bandwidth of the refractive index change, carrier density and electron temperature can be maximized. Generally, in the fast (sub μs) temporal regime when the modification threshold is reached, fast melting and resolidification can occur. In some applications, a laser wavelength below the semiconductor bandgap wavelength is employed. In these applications, strong surfacic one-photon photoionization can drive the absorption process causing limited tuning bandwidth due to weak and shallow material modification. In addition, photoionization driven semiconductor modification can lead to limited excited electron temperature and enhanced plasma shielding. Whereas employing laser pulses with a wavelength above the semiconductor bandgap wavelength can allow to get rid of direct photoionization and take advantage of deeper in-volume nonlinear absorption processes. Equally, it is known that higher electron temperature can be reached by increasing the laser wavelength of because the increased electron temperature effect of tunnel ionization, free-carrier absorption and impact ionization all scale with the square of the laser wavelength. To induce refractive index changes through a crystalline semiconductor phase, femtosecond to nanosecond pulses are used to create compressive stresses and in turn induce positive or negative refractive index change (e.g., 0.0002) at 1550 nm. To induce refractive index changes through an amorphization semiconductor phase, femtosecond to picosecond pulses are used to create fast quenching and in turn induce larger refractive index change (e.g., 0.06) at 1550 nm.

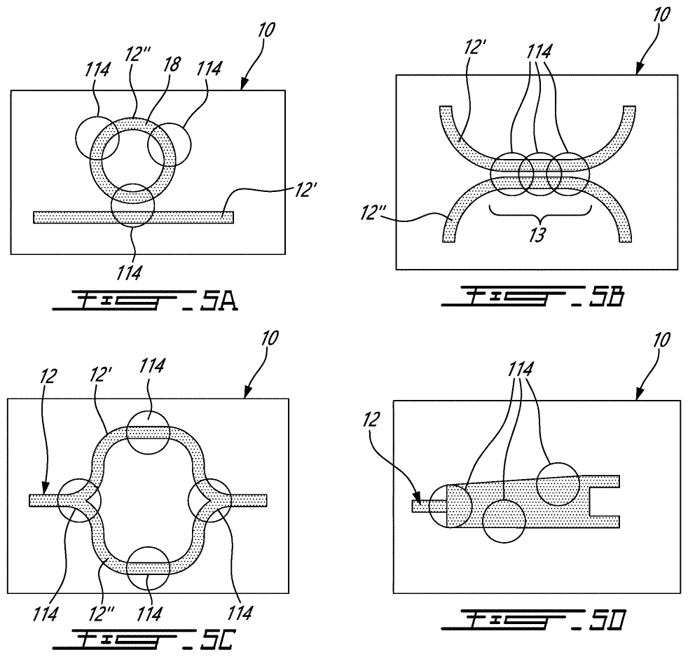

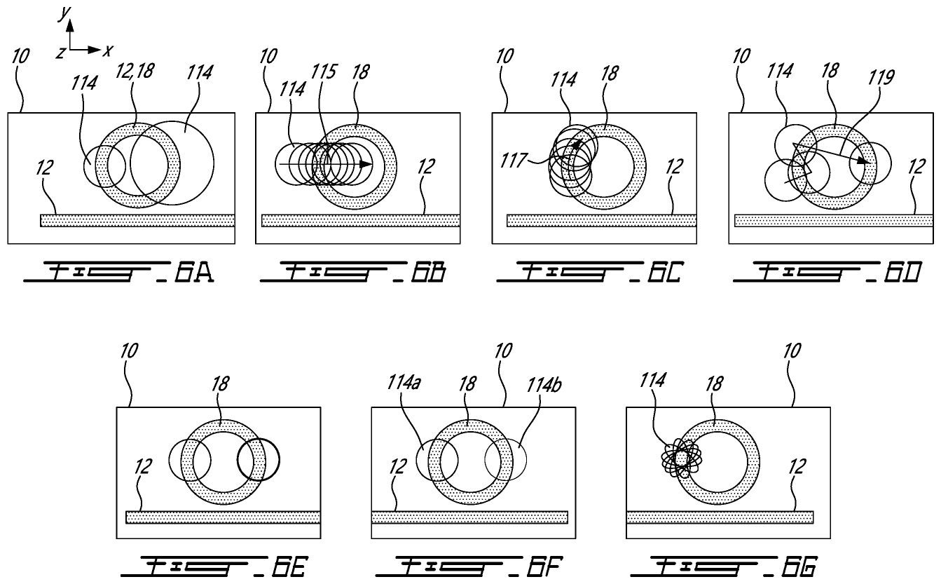

FIGS. 5A-D show examples of different photonic chips 10 having a semiconductor waveguide 12. It is understood that the semiconductor waveguide 12 is not limited to a single linear semiconductor waveguide but can rather encompass one or more than one semiconductor waveguides of any shape. In some cases, the semiconductor waveguide 12 forms a specific photonic function. For instance, FIG. 5A shows an example of a photonic chip 10 having a first semiconductor waveguide 12′ and a second semiconductor waveguide 12″ optically coupled to the first semiconductor waveguide. More specifically, the second semiconductor waveguide 12″ has a closed-loop shape forming a semiconductor resonator 18. In this specific example, the focal point 114 of the corrective laser beam can be directed to two or more circumferentially spaced apart locations around the semiconductor resonator 18. In some embodiments, each location is tapped with a single laser pulse of a given energy (referred to “laser tap” hereinafter). Accordingly, in this specific embodiment, the photonic chip 10 is modified using only three laser taps of the corrective laser beam. In some other embodiments, fewer than three laser taps or more than three laser taps can be used to modify the photonic chip 10. The laser taps can be spaced apart from one another or be directed at a common region of the photonic chip.

In FIG. 5B, the photonic chip 10 includes first and second semiconductor waveguides 12′ and 12″ having a coupling region 13 extending therebetween. In this configuration, the first and second semiconductor waveguides 12′ and 12″ may form an optical coupler such as a directional coupler. In this specific example, the focal point 114 of the corrective laser beam can be directed to two or more axially spaced apart locations along the coupling region 13, for instance. It is noted that the number and/or the location of the laser taps are only exemplary, as they could differ in some other embodiments.

In FIG. 5C, the photonic chip 10 has a semiconductor waveguide 12 splitting into two arms 12′ and 12″ which recombines to one another at a downstream location. In this specific embodiment, the semiconductor waveguide 12 can form a Mach-Zehnder interferometer. For instance, the focal point 114 of the corrective laser beam can be directed at a splitter region, across each of the two arms 12′ and 12″ and also at a combiner region of the semiconductor waveguide 12.

In FIG. 5D, the semiconductor waveguide 12 inverse-tapers and enlarges up to an output portion from which two auxiliary semiconductor waveguides 12′ and 12″ protrudes. In this configuration, the semiconductor waveguide 12 can form a multimode interferometer. The portions of the semiconductor waveguides 12 towards which the focal point 114 of the corrective laser beam is directed can vary from one embodiment to another. For instance, it can be directed at arbitrary regions along the multimode interferometer. It is understood that the example photonic functions that have been presented herein are only provided as examples, as other photonic functions can also be modified using the methods and systems described herein.

The number and/or locations of the laser tap can depend on the photonic function of the semiconductor waveguide. For instance, for a Mach-Zehnder interferometer (MZI), laser tap(s) can be directed to the coupling region or to the individual arms to modify a contrast of the MZI for instance from 45%-55% to 50%-50%, and/or a phase thereof. For a directional coupler, laser tap(s) can be directed to a coupling region to modify the overall coupling as it is known that the coupling ratio depend on the refractive index change between the two semiconductor waveguides of the coupling region. For a splitter (1×N), laser tap(s) can be directed in the coupling (multimodal) transition region to modify its coupling ratio and/or extinction ratio. For a combiner (M×1), laser tap(s) can be directed in the coupling (multimodal) transition region to modify its combining ratio and/or the phase in each arm. For a microring resonator (MRR), laser tap(s) can be directed in the coupling region or in the ring section to modify its resonant wavelength, Q-factor and/or extinction ratio as it is known that transmission of thru or drop ports depends directly on the round-trip phase inside the ring which in turns depends on the refractive index of the semiconductor waveguide inside the ring. For arrayed waveguide grating (AWG), laser tap(s) can be directed in the coupling (multimode) transition region to modify the coupling in one channel relative to the coupling in the other channels. For a taper, laser tap(s) can be directed in a tapered region to modify its losses, change nonlinear and dispersive properties. For grating couplers, laser tap(s) can be directed on the grating to modify its injection efficiency. For Bragg gratings, laser tap(s) can be directed along the Bragg grating to modify it's wavelength, Q-factor and/or extinction ratio. For optical detectors, laser tap(s) can be directed along the detector to modify its detection efficiency or annealing. For distributed feedback lasers (DFB), laser tap(s) can be directed to the active region to modify its wavelength. The embodiments listed above are meant to be exemplary only.

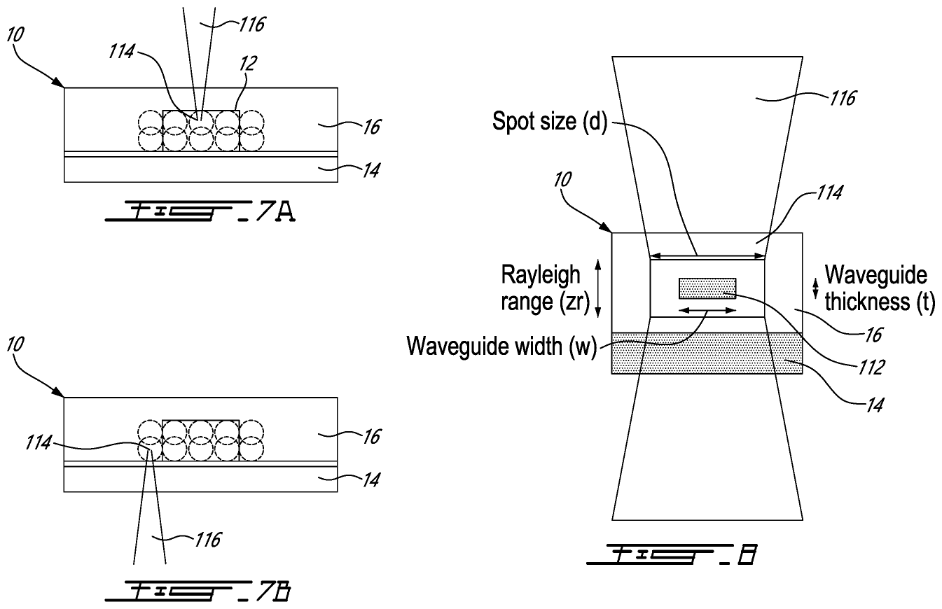

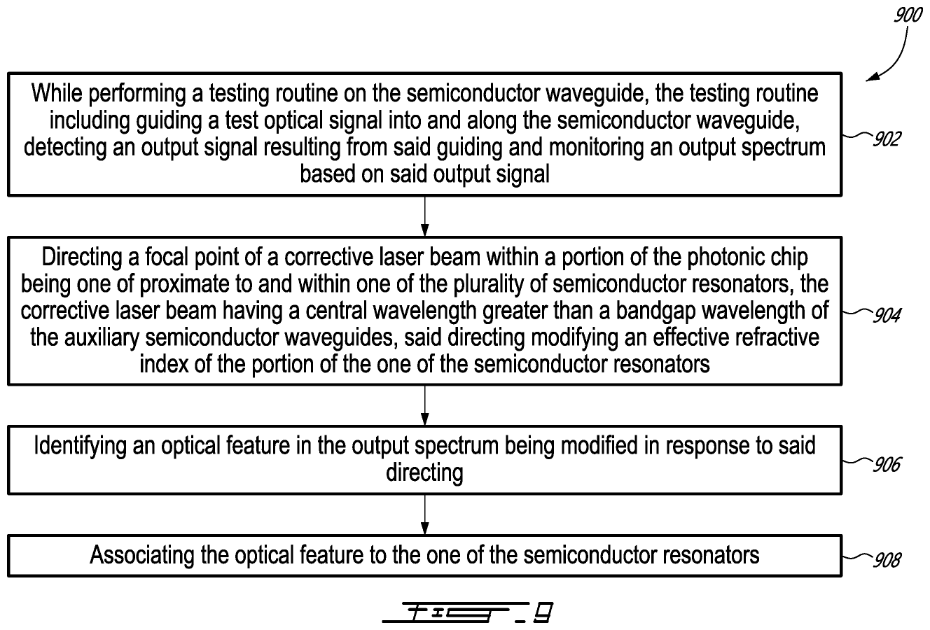

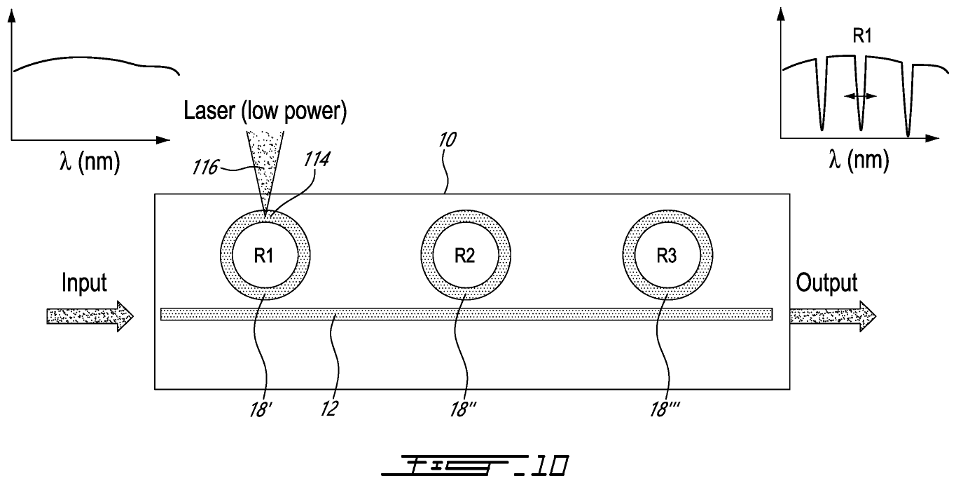

FIGS. 6A-6G show an example of a photonic chip 10 having a semiconductor waveguide 12 and a semiconductor resonator 18 optically coupled to the semiconductor waveguide 12. Although the semiconductor resonator 18 has a closed-loop shape, it is understood that the semiconductor resonator 18 is also considered a semiconductor waveguide 12. Accordingly, the step of directing the focal point 114 of the corrective laser beam either within or proximate to the semiconductor waveguide 12 is meant to encompass a situation where the focal point 114 of the corrective laser beam is directed either within or proximate to the semiconductor resonator 18. In other words, the semiconductor waveguide 12 can include the semiconductor resonator 18.

In FIG. 6A, the corrective laser beam 114 is first directed to a first portion of the semiconductor resonator 18 and then directed to a second portion of the semiconductor resonator 18, or vice versa. As shown, the first portion is located at a first circumferential position of the semiconductor resonator 18 while the second portion is located a second circumferential position which is diametrically opposite to the first circumferential position. However, in some other embodiments, the two portions can be circumferentially spaced apart by 10 degrees, 25 degrees, 90 degrees and the like. In this specific example, the focal point 114 of the corrective laser beam can be moved along a z-axis thereby increasing the area of the second portion relative to the first portion. As such, the second portion can have a larger area (e.g., 10 μm) than an area (e.g., 1 μm) of the first portion. It is noted that the first and second portions can each receive one or more laser pulses or an exposition to continuous wave (CW) laser for a given period of time. In some other embodiments, two different laser corrective laser beams can be used.

In FIG. 6B, the focal point 114 of the corrective laser beam is moved radially inwardly along a linear path 115 across a portion of the semiconductor resonator 18. However, in some other embodiments, the focal point 114 of the corrective laser beam can be moved radially outwardly across the portion of the semiconductor resonator 18. In this embodiments, overlap between successive laser taps can result in enhanced optical energy delivery at these overlapped portions.

In FIG. 6C, the focal point 114 of the corrective laser beam is moved tangentially along an arced path 117 along a portion of the semiconductor resonator 18. Although the arced path 117 is shown to be in the clockwise direction of rotation, the arced path 117 can also be in the counter clockwise direction of rotation depending on the embodiment. The arced path 117 can extend for 15 degrees, 20 degrees, 45 degrees or any other circumferential arc or offset.

In FIG. 6D, the path 119 made by the focal point 114 of the corrective laser beam is arbitrary relative to the semiconductor waveguide 12. It is understood that a scanning speed at which the focal point 114 of the corrective laser beam is moved along the path can be constant or varying over time depending on the embodiment.

In FIG. 6E, the corrective laser beam is adjusted between successive laser taps to modify its intensity. More specifically, the first portion of the semiconductor resonator 18 is illuminated with a first intensity or first pulse energy of the corrective laser beam whereas the second portion of the semiconductor resonator 18 is illuminated with a second intensity or second pulse energy which is greater than the first intensity or pulse energy, or vice versa. For instance, the first pulse energy can be 100 nJ while the second pulse energy can be 1000 nJ. There can be more than one corrective laser beam in some embodiments.

For instance, and as shown in FIG. 6F, a first focal point 114a of a first corrective laser beam is directed to a first portion of the semiconductor resonator 18 whereas a second focal point 114b of a second corrective laser beam is directed to a second portion of the semiconductor resonator. In this specific embodiment, the first and second corrective laser beams have different central wavelengths. However, the central wavelengths of both the first and second corrective laser beams are greater than the bandgap wavelength of the semiconductor resonator so as to be propagated through the photonic chip 10. For instance in this embodiment the spectral bandwidth of the first corrective laser beam can centered at about 1550 nm while the spectral bandwidth of the second corrective laser beam can be centered at about 2800 nm.

In FIG. 6G, a single portion of the semiconductor resonator 18 is illuminated with different spatial modes of the corrective laser beams. For instance, the portion can be modified using a first spatial mode of light (e.g., LP01) whereas it can be modified using a second spatial mode of light (e.g., LP02, LP11, LP21) different from the first spatial mode of light. In other embodiments, different portions of the semiconductor resonator are modified using different spatial modes of light.

Referring now to FIGS. 7A and 7B, the photonic chip 10 has a substrate 14, a semiconductor waveguide 12 atop the substrate 14 and a cladding layer 16 covering the semiconductor waveguide 12 and a top surface of the substrate 14. In these embodiments, it is noted that the focal point 114 of the corrective laser beam can be directed within or proximate to the semiconductor waveguide 12 through the cladding layer 16 from above such as shown in FIG. 7A or through the substrate 14 from below such as shown in FIG. 7B. In some embodiments, the corrective laser beam 116 can be directed through one or more waveguides, cladding layers, or other layers of material to reach the desired semiconductor waveguide 12 of interest. As shown, the focal point 114 of the corrective laser beam can be directed within the semiconductor waveguide 12 or proximate thereto. In these embodiments, it is understood that the substrate 14 and the cladding layer 16 also have the bandgap wavelength and/or optical transmission window allowing transmission of the corrective laser beam 116. In embodiments where refractive index modification is performed within the semiconductor waveguide 12, the effective refractive index of the semiconductor waveguide 12 can change. In embodiments where an external refractive index modification is performed slightly outside the semiconductor waveguide 12, e.g., within the adjacent cladding layer, it is understood that the effective refractive index of the semiconductor waveguide 12 can change as well. Indeed, as an optical beam propagating along the semiconductor waveguide 12 typically has an evanescent tail extending outside of the semiconductor waveguide, if the evanescent tail reaches the external refractive index modification, it will impact the optical signal and thus the effective refractive index of the semiconductor waveguide 12.

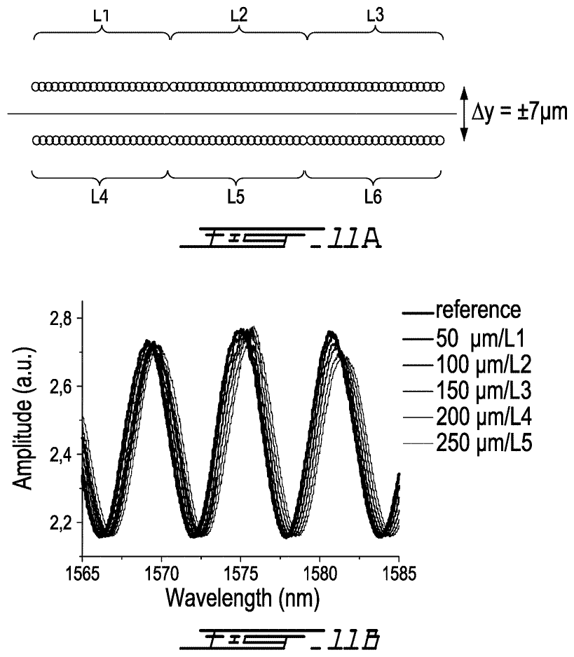

It is encompassed that the size of the focal spot relative to the size of the semiconductor waveguide can vary from one embodiment to another. Referring now to FIG. 8, the focal spot 114 can have a Rayleigh range (depth of focus, zr) extending along the corrective laser beam and a spot size (d) extending laterally across the corrective laser beam. The semiconductor waveguide 12 has a waveguide width w extending in a plane of the photonic chip 10 and a thickness t extending across the plane of the photonic chip 10. As shown in this specific embodiment, the spot size is larger than the waveguide width w and the Rayleigh range zr is larger than the waveguide thickness t. However, in some other embodiments, the spot size d can be smaller than the waveguide width w. Additionally or alternatively, the Rayleigh range zr of the focal spot of the corrective laser beam can be smaller than the waveguide thickness t. Any combination of these dimensions can be used depending on the embodiments.

In another aspect, FIG. 9 shows a flow chart of an example of a method 900 of testing a photonic chip. In this aspect, the photonic chip has a semiconductor waveguide and a number of semiconductor components optically coupled to the semiconductor waveguide. Each of the semiconductor components has a bandgap wavelength. In some embodiments, the semiconductor component is a semiconductor resonator such as a ring resonator or a photonic crystal resonator, a semiconductor and the like.

At step 902, a testing routine is performed on the semiconductor waveguide. More specifically, the testing routine including a step of guiding a test optical signal into and along the semiconductor waveguide, a step of detecting an output signal resulting from the guiding and a step of monitoring an output spectrum based on the output signal. In some embodiments, the output spectrum can be an optical output spectrum, a radio-frequency output spectrum, and the like. While the testing routine is being performed, the step 902 includes another step of directing a focal point of a probing laser beam within a portion of the photonic chip being one of proximate to and within one of the semiconductor components. It is noted that the probing laser beam has a central wavelength which is greater than the bandgap wavelength of the semiconductor components. Additionally or alternatively, it is intended that the central wavelength can partially or wholly overlap with an optical transmission window of the semiconductor components. As such, the semiconductor components are optically transparent to the probing laser beam. The step 902 results in a step of modifying an effective refractive index of the portion of the one of the semiconductor components. In some embodiments, multiple semiconductor components can be laser tapped in one or many iterations.

At step 904, an optical feature is identified in the output spectrum which has been modified in response to the step 902 of directing. Examples of optical features can include, but are not limited to, spectral features, resonant features and the like.

At step 906, the optical feature is associated to the one of the semiconductor components.

In this way, if a photonic chip has a significant number of components, the method 900 can be used to map the optical features of the output spectrum to corresponding semiconductor components. It is noted that the method 900 is generally performed with an aim of identifying and/or mapping, with no intention to cause significant effective refractive index variations. Accordingly, the step of directing can be limited to lower power to modify the effective refractive index only by an inconsequential amount. For instance, the effective refractive index of the portion of the semiconductor waveguide can be modified by an amount ranging between about 0.01 and about 0.00001, preferably between about 0.001 and about 0.00005 and most preferably between about 0.005 and about 0.0001. In some embodiments, the refractive index modifications can be only temporary or permanent.

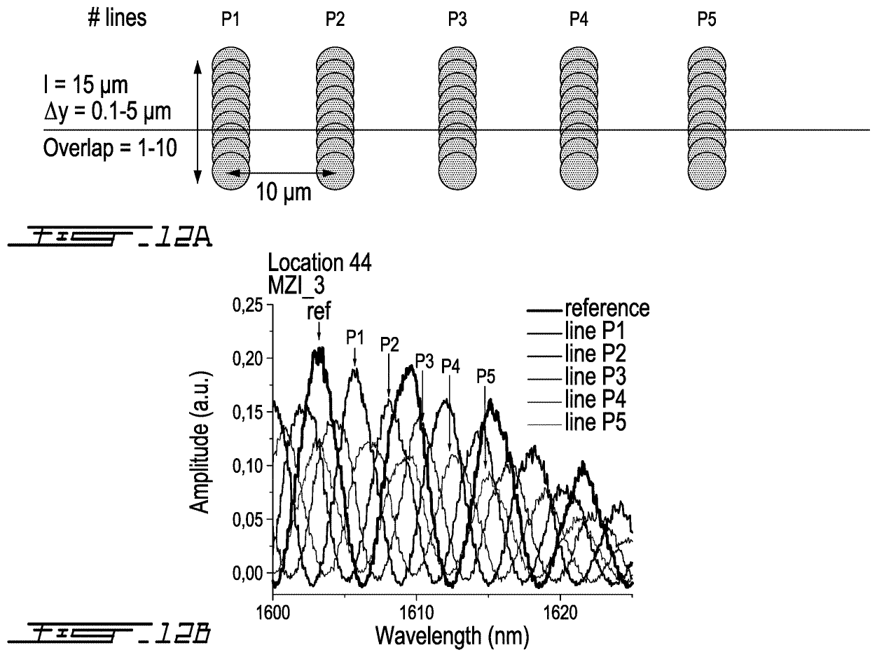

As shown in the embodiment of FIG. 10, a photonic chip 10 having a main semiconductor waveguide 12 and three auxiliary semiconductor components 18′, 18″ and 18″′ optically coupled to the main semiconductor waveguide 12. Each semiconductor component has its own optical feature such as a spectral resonance, for instance, with the optical features being different from one another. In this embodiment, a testing routine is performed in a continuous fashion to monitor optical features R of each of the auxiliary semiconductor components 18′, 18″ and 18″′. By directing the focal point 114 of the probing laser beam 116 onto a given one of the auxiliary semiconductor components 18′, 18″ and 18″′, the testing routine shows that optical feature R1 experiences a slight spectral shift. As such, the given auxiliary semiconductor component 18′ can be associated to the optical feature R1. Accordingly, if it is later found that the optical feature R1 is a parameter which mismatch to a corresponding reference parameter, the focal point 114 of the probing laser beam 116 can then be used to deliver a greater amount of optical energy to the given auxiliary semiconductor components 18′ so as to modify its effective refractive index until the measured parameter matches the reference parameter within a given tolerance.

Experiments have been conducted using the methods and systems described herein to demonstrate that fine and coarse tuning of the effective refractive index of a semiconductor waveguide can be effectively achieved. One of these experiments involves a photonic chip having a Mach-Zehnder interferometer (MZI) formed using one or more semiconductor waveguides. More specifically, the MZI has a main semiconductor waveguide which splits, at a first coupling point, into two MZI arms of equal lengths. The two MZI arms recombine at a second coupling point downstream from the first coupling point. As can be understood, when an optical signal propagates along the main semiconductor, it will split into two optical signal portions which will either destructively or constructively interfere once recombined at the second coupling point. Typically, if the lengths or the effective refractive indexes of the MZI arms are similar, the optical signal portions will experience similar propagation conditions in each of the MZI arms and the interference occurring at the second coupling point will be constructive. However, if a difference in length, or if a difference in effective refractive indexes, exists between the two MZI arms, then the MZI can become unbalanced resulting in spectral modulation of the optical signal after the recombination, which can be observed in the outputted optical signal.

In this experiment, subsequent sets of refractive index modifications were made proximate to only one MZI arm of an equal arm length MZI such as the one discussed above. The spectral responses of the resulting MZIs were measured after each set of refractive index modifications. As schematically shown in FIG. 11A, the sets correspond to linear passes L1, L2, . . . L6 of the focal point of the corrective laser beam proximate to and parallel to the MZI arm. The linear passes L1, L2 and L3 have been made on one lateral side of the MZI arm as the other passes L4, L5 and L6 have been made on the other lateral side of the MZI arm. In this specific embodiment, each linear pass has a length of about 50 μm and is laterally spaced apart from the MZI arm from about 7 μm. As best shown in FIG. 11B, which shows the spectral responses measured following each one of the above-discussed series of linear passes, the spectral response of the MZI varies slightly with each additional linear pass. The results shown in FIG. 11B confirm that by carefully positioning the refractive index modifications proximate to the MZI arm, a subtle or fine-tuning of the effective refractive index of a semiconductor waveguide can be achieved when desired.

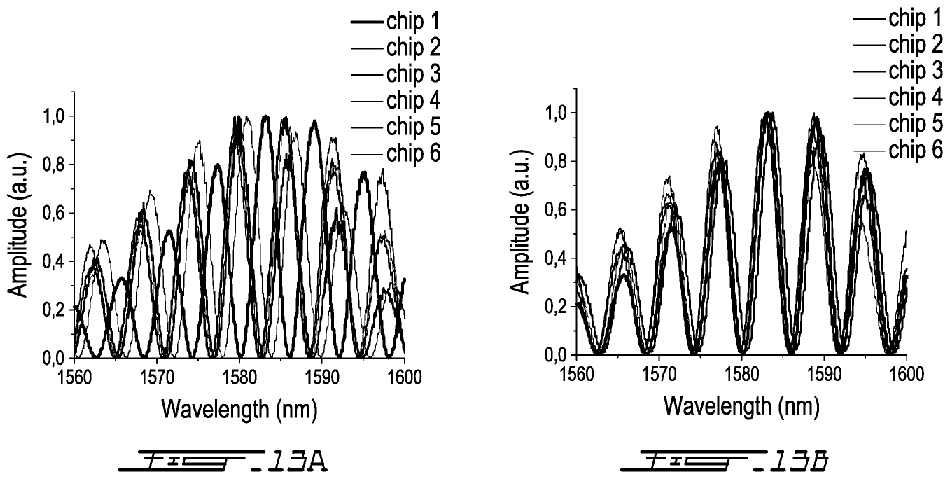

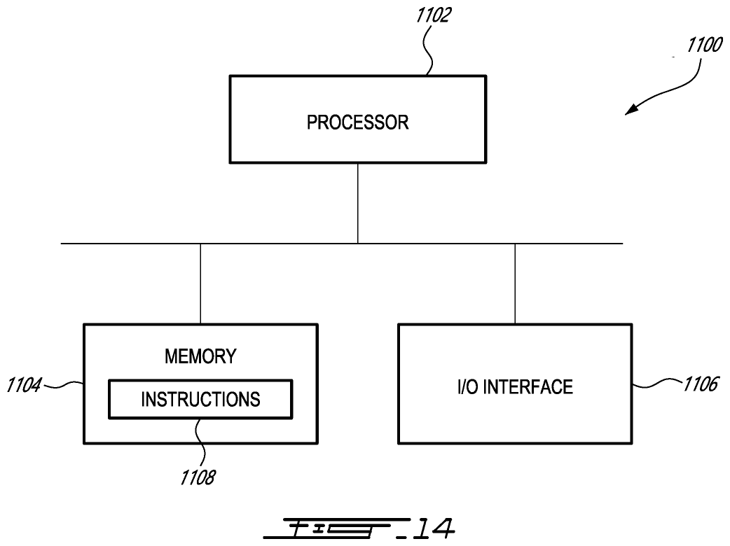

In another experiment, subsequent sets of refractive index modifications were made within only one of the MZI arms of an equal arm length MZI such as the one discussed above. The spectral responses of the resulting MZIs were measured after each set of refractive index modifications. As shown in FIG. 12A, the sets correspond to linear passes P1, P2, . . . P6 of the focal point of the corrective laser beam within and across the MZI arm. Each of these linear passes is about 15 μm long, and are spaced apart from one another by about 10 μm. As shown in FIG. 12B, it was demonstrated that a coarser tuning of the effective refractive index of a semiconductor waveguide can be effectively achieved with such intrusive refractive index modifications.

In yet another experiment, six different photonic chips each having a corresponding MZI have been manufactured using known techniques. As shown, the spectral responses of these MZIs greatly differ from one another as is usually the case in the industry. However, using the methods and systems described herein, the six different photonic chips were modified using refractive index modifications applied proximate to and/or within the semiconductor waveguides to cause both coarse and fine-tuning of their respective spectral responses until they reach a reference parameter.

It is noted that the controller discussed above with reference to FIG. 1 can be provided as a combination of hardware and software components. The hardware components can be implemented in the form of a computing device 1100, an example of which is described with reference to FIG. 14. Moreover, the software components of the controller can be implemented in the form of a software application performing some or more steps of a method of modifying a photonic chip or a method of testing a photonic chip.

Still referring to FIG. 14, the computing device 1100 can have a processor 1102, a memory 1104, and I/O interface 106. Instructions 1108 for performing the methods 400 or 900 described above can be stored on the memory 1104 and accessible by the processor 1102.

The processor 1102 can be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 1104 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 1106 enables the computing device 1100 to interconnect with one or more input devices, such as a photonic chip testing apparatus, detector(s), a computer vision system, or with one or more output devices such as a multi-axis movement stage, an external network or an accessible memory system.

Each I/O interface 1106 enables the controller to communicate with other components, to exchange data with other components, to access and connect to network resources, to server applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The controller can run one or more software applications configured to operate the system described herein using instructions 108. In some embodiments, the software applications are stored on the memory 1104 and accessible by the processor 1102 of the computing device 1100. The computing device 1100 and the software applications described above are meant to be examples only. Other suitable embodiments of the controller 1132 can also be provided, as it will be apparent to the skilled reader.

As can be understood, the examples described above and illustrated are intended to be exemplary only. For instance, the methods and systems described herein can be performed using more than one corrective laser beam. It is noted that a photonic chip can have a multitude of photonic functions and/or photonic components each having dedicated channels. The methods and systems described here can be applied to each of the photonic functions, each of the photonic components and each of the photonic channels of the photonic chip 10. Depending on the embodiment, the characteristics of the corrective laser beam can be varied. Examples of such characteristics can include, but are not limited to, pulse duration, repetition rate, burst mode or not, pulse energy, laser wavelength, laser intensity, beam shape (e.g., Gaussian, top-edge, Bessel, elliptical), fixed or moving beam, scan speed, hatch and laser path, to name a few examples. The number and/or locations of the laser taps can depend based on a geometry and material of the semiconductor waveguide. Moreover, the methods and systems described herein can be adapted to limit losses incurred to the photonic chip, to ensure precise positioning of the corrective laser beam relative to the photonic chip, to maximize a compensation range and to impart positive or negative refractive index changes. When the semiconductor waveguide is surrounded by many layers of material (e.g., glass insulator, other semiconductor layers), the effective refractive index change can be selective to the particular layer. Refractive index can be changed by different processes including, but not limited to, amorphization, stress induced, void creation, densification and the like. The laser-induced refractive index modification can be paired with other sources of heating, e.g., thermal heater(s), sources(s) of ionization (e.g., input voltage in the semiconductor waveguide) or another laser beam absorbed by the semiconductor waveguide, to optimize the methods and systems described herein. The corrective laser beam can be perpendicular to a plane of the photonic chip or have an acute or obtuse angle with respect to a plane of the photonic chip. Structures such as fiber-Bragg gratings or polarisers can be created with the effective refractive index change inside the semiconductor waveguide in some embodiments. It is understood that modifying the effective refractive index can include a modification of the real part of the refractive index, a modification of the imaginary part of the refractive index, or a combination thereof. In some embodiments, the central wavelength of the corrective laser beam can be adapted to control the process parameters and optimize correction depending on the type of semiconductor material. In some embodiments, the refractive index modifications can be imparted in such a way that can influence the polarization of the optical signal propagating along the semiconductor waveguide. For instance, the refractive index modifications can extend on opposite sides of the semiconductor waveguide to maintain or change polarization. In one specific embodiment, refractive index modifications such as those shown in FIG. 11A can be used to mimic the structure of polarization-maintaining optical fibers, to name only one example. In embodiments where the photonic chip is based on the InP semiconductor platform, such refractive index modifications can form matrix defects which can attract electrons and thereby reduce optical losses occurring along the semiconductor waveguide. Although the semiconductor waveguide shown in the example above is rather simple and unidimensional, complex structures for the semiconductor waveguide can be used in some other embodiments. For instance, the semiconductor waveguide can include one or more semiconductor waveguides running alongside each other, and the matrix (e.g., glass matrix) extending between them. The scope is indicated by the appended claims.

1. A method of modifying a photonic chip having a semiconductor waveguide, the semiconductor waveguide having a bandgap wavelength, the method comprising:
directing a focal point of a corrective laser beam within a portion of the photonic chip being one of proximate to and within the semiconductor waveguide, the corrective laser beam having a central wavelength greater than the bandgap wavelength of the semiconductor waveguide, said directing modifying an effective refractive index of the portion of the semiconductor waveguide;
performing a testing routine on the semiconductor waveguide including determining a parameter indicative of a performance of the semiconductor waveguide; and
upon determining that said parameter mismatches a reference parameter associated with a reference photonic chip, repeating said directing and said testing routine until said parameter matches the reference parameter within a given tolerance.

2. The method of claim 1 wherein said directing includes moving at least one of the focal point of the corrective laser beam and the photonic chip along a path.

3. The method of claim 2 wherein said moving includes delivering a laser pulse at each of a plurality of spaced apart points distributed along the path.

4. The method of claim 1 wherein said testing routine includes guiding a test optical signal into and along the semiconductor waveguide, detecting an output signal resulting from said guiding and determining the parameter based on said output signal.

5. The method of claim 4 wherein said guiding includes injecting the test optical signal at a first end of the semiconductor waveguide.

6. The method of claim 5 wherein said detecting includes measuring the output signal using a photodiode optically coupled to a second end of the semiconductor waveguide.

7. The method of claim 4 wherein said detecting includes measuring the output signal scattering away from the semiconductor waveguide during said guiding using a camera.

8. The method of claim 1 wherein the parameter is at least one of an output wavelength, an output phase, an output amplitude, an output polarization, an output dispersion and an output loss.

9. The method of claim 1 wherein the central wavelength of the corrective laser beam ranges between about 1 μm and about 20 μm, preferably between about 1.2 μm and about 10 μm and most preferably about between about 1.5 μm and about 4 μm.

10. The method of claim 1 wherein the corrective laser beam has laser pulses having a time duration ranging between about 10 fs and about 1000 ns, preferably between about 100 fs and about 500 ns and most preferably between about 250 fs and about 250 ns.

11. The method of claim 1 wherein the semiconductor waveguide is positioned relative to a substrate, the photonic chip further having a cladding layer covering a top surface of the substrate and the semiconductor waveguide, said directing including directing the focal point of the corrective laser beam through at least one of the cladding layer and the substrate.

12. The method of claim 1 wherein the photonic chip has a plurality of semiconductor waveguides each having the bandgap wavelength, the method further comprising performing said directing and said testing routine with respect to each one of the plurality of semiconductor waveguides until a plurality of parameters pertaining to the plurality of semiconductor waveguides match a respective reference parameter within a given tolerance.

13. A system for modifying a photonic chip having a semiconductor waveguide, the semiconductor waveguide having a bandgap wavelength, the system comprising:
a corrective laser apparatus configured for directing a focal point of a corrective laser beam within a portion of the photonic chip being one of proximate to and within the semiconductor waveguide, the corrective laser beam having a central wavelength greater than the bandgap wavelength of the semiconductor waveguide, said directing modifying an effective refractive index of the semiconductor waveguide;
a photonic chip testing apparatus performing a testing routine on the semiconductor waveguide including determining a parameter indicative of a performance of the semiconductor waveguide; and
a controller communicatively coupled to the corrective laser apparatus and to the photonic chip testing apparatus, the controller having a processor and a memory having stored thereon instructions that when executed by the processor perform the steps of:
comparing said parameter to a reference parameter associated with a reference photonic chip; and
upon determining that said parameter mismatches the reference parameter, repeating said directing and said testing routine until said parameter matches the reference parameter within a given tolerance.

14. The system of claim 13 wherein the corrective laser apparatus includes a laser source generating the corrective laser beam, the central wavelength ranging between about 1.0 μm and about 20 μm, preferably between about 2.5 μm and about 10 μm and most preferably about between about 2.8 μm and about 3.4 μm.

15. The system of claim 13 wherein the corrective laser apparatus includes a laser source generating laser pulses having a time duration ranging between about 10 fs and about 1000 ns, preferably between about 100 fs and about 500 ns and most preferably between about 250 fs and about 250 ns.

16. The system of claim 13 wherein the corrective laser apparatus has a fiber laser source.

17. The system of claim 13 further comprising a multi-axis movement stage having a support area on which the photonic chip is received, the multi-axis movement stage moving the photonic chip during said directing.

18. The system of claim 13 wherein said photonic chip testing apparatus includes a test optical source guiding a test optical signal into and along the semiconductor waveguide, and a detector detecting an output signal resulting from said guiding, the controller determining the parameter based on said output signal.

19. The system of claim 13 wherein said detector is a photodiode optically coupled to a first end of the semiconductor waveguide for detecting the output signal.

20. (canceled)

21. A method of testing a photonic chip, the photonic chip having a semiconductor waveguide and a plurality of semiconductor components optically coupled to the semiconductor waveguide, the semiconductor components having a bandgap wavelength, the method comprising:
while performing a testing routine on the semiconductor waveguide, the testing routine including guiding a test optical signal into and along the semiconductor waveguide, detecting an output signal resulting from said guiding and monitoring an output signal based on said output signal, directing a focal point of a probing laser beam within a portion of the photonic chip being one of proximate to and within one of the plurality of semiconductor components, the corrective laser beam having a central wavelength greater than the bandgap wavelength of the semiconductor components, said directing modifying an effective refractive index of the portion of the one of the semiconductor components;
identifying an optical feature in the output spectrum being modified in response to said directing; and
associating the optical feature to the one of the semiconductor components.

22-23. (canceled)
